(19) United States
(12) Patent Application Publication
(10) Pub. No.: US 2014/0269977 A1
(43) Pub. Date: Sep. 18, 2014

(54) WIRELESS DEVICE AND METHOD FOR ANTENNA SELECTION

(71) Applicant: Songnan Yang, San Jose, CA (US)

(72) Inventor: Songnan Yang, San Jose, CA (US)

(21) Appl. No.: 13/992,491

(22) PCT Filed: Dec. 29, 2011
(86) PCT No.: PCT/US11/67928

§ 371 Date: Jul. 18, 2013

(51) Int. Cl. H04B 7/08; H04B 7/06; H04W 52/42; H04B 7/04

(52) U.S. Cl. CPC H04B 7/0834; H04B 7/0413; H04B 7/0602; H04W 52/42
USPC 375/295

(57) ABSTRACT

Embodiments, such as apparatus or techniques may include circuitry for a portable wireless device. In an embodiment, a tissue proximity detection circuit may be configured to provide information indicative of a presence or absence of human tissue within a specified range of a first antenna, and an antenna control circuit may be configured to controllably inhibit transmission by the first antenna, and to permit transmission by a second antenna, in response to information provided by the tissue proximity detection circuit that tissue is present within the specified range of the first antenna.

### TECHNICAL FIELD

This document pertains generally, but not by way of limitation, to antenna selection techniques for wireless communication.

### BACKGROUND

Wireless communication devices are subject to various regulatory requirements before they may be manufactured for sale, sold, or used. Such regulatory requirements may specify human exposure limits for electromagnetic energy that may be emitted from such communication devices. Such communication devices may include cellular communication devices such as “smart” phones, digital or analog radio communication systems, portable computers such as laptops, tablet devices such as including a touch-screen, or a variety of other devices.

Regulatory limits related to human exposure to electromagnetic energy from wireless devices may be specified in terms of a Specific Absorption Rate (SAR). SAR generally refers to an integral over a sample volume of a ratio of an electric field intensity times a conductive of the sample, divided by a density of the sample. The sample might include a tissue-simulating slab such as emulating or shaped like a human body, a human torso, a human head, or one or more appendages such as arms or hands. SAR may be experimentally determined via measurement, or estimated via simulation. For example, an electric field intensity may be measured or simulated, and SAR may then be determined such as for a known sample conductivity, volume, or material density. SAR is generally specified in terms of power dissipation per unit mass, such as in Watts per Kilogram (W/kg) in the S.I. unit system. For example, the United States Federal Communications Commission (FCC) has adopted SAR exposure limits such as generally specified in ANSI/IEEE C95.1-1992, but such exposure limits may be revised or may differ from one region to another.

During regulatory approval testing, such measurement or simulation may include using a tissue-simulating model having characteristics similar to a human test subject. Such a model may be referred to as a “phantom.”

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an embodiment, such as a portion of a portable wireless device, which may include one or more processors, and one or more memory circuits.

FIG. 2 illustrates generally an embodiment, such as a portable wireless device, that may include a tissue proximity detection circuit and an antenna control circuit.

FIG. 3 illustrates generally a technique, such as a method, that may include obtaining information indicative of a presence or absence of human tissue and controllably inhibiting transmission by an antenna in response to the obtained information.

FIG. 4 illustrates generally an illustrative embodiment of a technique, such as a method, that may include detecting a presence or absence of human tissue nearby a proximity sensor and in response, selecting an antenna for use in transmission.

### DETAILED DESCRIPTION

Conformity to a regulatory SAR exposure limit for electromagnetic emissions may be quite challenging for wireless communication devices having an embedded wireless radio. Such a radio may include one or more of a second-generation (2G) digital radio, such as a Global System for Mobile communication (GSM) digital radio, a wide-area-network (WWAN) radio, such as a third-generation or fourth-generation (3G/4G) digital radio, or one or more other communication circuits.

In one approach, testing of such a tablet assembly may include power “throttling,” or adjusting a transmit power such as using a fixed attenuation factor determined during regulatory testing or using a power level adjusted dynamically in response to obtained information about a proximity of human tissue to the antenna.

The present inventor has recognized, among other things, that such a fixed or dynamic power reduction may adversely impact wireless communication performance, such as causing unwanted dropouts, an unwanted reduction in usable wireless communication range, an unwanted reduction in a rate of communication, or other unwanted effects. The present inventor has also recognized that providing multiple transmission antenna locations around a portable communications device housing reduces the likelihood that all antennas will be located near tissue simultaneously. In an embodiment, a transmission antenna may be selected using information about an absence or presence of human tissue nearby the antenna.

Use of transmit antenna selection techniques, such as discussed in the embodiments above and below may generally improve a user's perception of wireless communication performance such as by allowing a portable wireless device to maintain a desired total radiated power (TRP) without violation of regulatory exposure limits.

FIG. 1 illustrates generally an embodiment, such as a portion of a portable wireless device 100, which may include one or more processors and one or more memory circuits. For example, the portable wireless device 100 may include a processor 102 and a memory circuit 104. One or more of the processor 102 or memory circuit 104 may include instructions 124 that cause the portable wireless device 100 to perform operations, such as discussed in one or more embodiments below.

In an embodiment, the portable wireless device 100 may include a wireless communication circuit 116, such as including one or more wireless transceivers. The wireless communication circuit 116 may be configured to operate in accordance with one or more wireless standards. For example, the wireless communication circuit may be configured to wirelessly transfer information between the portable wireless device 100 and a remote apparatus or network 118 via a communication link 120. Such a communication link 120 may be established in accordance with one or more communications standards, such as a second-generation (2G) digital wireless communication standard, such as a GSM or GSM-derived standard, a third-generation (3G) standard, a fourth-generation (4G) standard, or in accordance with one or more other standards or protocols.

Such a 3G or 4G digital wireless communication standard may include one or more of a WiMax communication standard (e.g., in accordance with the IEEE 802.16 family of standards such as IEEE 802.16-2009), a Third-Generation Partnership Project (3GPP) Long-Term-Evolution (LTE) communication standard, or one or more other standards or protocols. In an embodiment, the wireless communication circuit may be configured to wireless transfer information in accordance of a Wi-Fi wireless local-area-networking (WLAN) standard, such as one or more of the IEEE 802.11 family of standards (e.g., IEEE. 802.11a-1999, 802.11b-1999, 802.11g-2003, 802.11n-2009, 802.11-2007), or one or more other standards or protocols.

In an embodiment, one or more of the processor 102, memory circuit 104, or wireless communication circuit 116 may be coupled to other portions of the portable wireless device 100 such as via a link 108. For example, the portable wireless device 100 may include a display device 110 or an input device 112. The portable wireless device 100 may include one or more of a laptop or handheld computing assembly, a tablet assembly, a cellular communication device, a digital radio, or one or more other assemblies or devices.

In an embodiment, the portable wireless device 100 may include a tissue proximity detection circuit, such as configured to detect a presence or absence of human tissue in proximity to one or more portions of the portable wireless device. In an embodiment, the portable wireless device 100 may include an antenna control circuit 106, such as coupled to the wireless communication circuit. The antenna control circuit 106 may be configured to select or adjust a transmit antenna, a receive antenna, or other communication parameters such as a transmit power, such as in response to information obtained from the tissue proximity detection circuit 114.

In an embodiment, one or more of the processor 102, the memory circuit 104, the wireless communication circuit 116, the antenna control circuit 106, the tissue proximity detection circuit 114, or one or more other devices or modules, may be co-integrated on or within a commonly-shared integrated circuit (IC) die, integrated circuit package, IC chipset, or module.

FIG. 2 illustrates generally an embodiment, such as a portable wireless device 200, that may include a tissue proximity detection circuit 114 and an antenna control circuit 116. Similar to the embodiments discussed above with respect to FIG. 1, the portable wireless device 200 may include one or more of a tablet assembly or a cellular communication device (e.g., a tablet computer or e-reader, a smart-phone, etc.). In an embodiment, the portable wireless device 200 may include a housing 128, such as including a display 110, and one or more user inputs such as a pushbutton 112. In an embodiment, the display 110 may also be used as a user input, such as including a touch-screen display.

As discussed above, the present inventor has recognized, among other things, that such a fixed or dynamic transmission power reduction may adversely impact wireless communication performance. The present inventor has also recognized that transmit antenna selection may be used in addition to power adjustment, or instead of power adjustment, such as during regulatory SAR certification testing, carrier compliance testing, or during end-use by a user.

In an embodiment, the housing 128 may include a first antenna 124A, such as located near a first proximity sensor 122A, such as on or within a first edge 126A of the housing 128. Similarly, a second antenna 124B may be located on or within a second edge 126B of the housing 128, such as located near a second proximity sensor 122B. One or more of the first or second proximity sensors 122A through 122B may be communicatively coupled to a tissue proximity detection circuit 114. One or more of the first or second antennas 124A through 124B may be communicatively coupled to a wireless communication circuit 116.

SAR testing of electromagnetic emissions for regulatory approval may involve placing a device-under-test (DUT) in a variety of configurations nearby or against a tissue-simulating phantom. For notebook computing devices, such testing may not be required at all because such computing devices might include an antenna that may be located more than 20 centimeters away from human tissue in most usage scenarios. A smart-phone or other cellular device may be allowed to be tested nearby the tissue simulating phantom, such as with a 20 millimeter spacing. A tablet assembly, such as the portable wireless device 200 of FIG. 2, may face the most stringent test requirements, such as being tested with zero clearance between the tissue simulating phantom and a back of the housing 128.

In one approach, a transmission power level may be adjusted to achieve compliance with SAR exposure thresholds, such as not to exceed a SAR exposure threshold. For example, in an assembly having only a single antenna or having antennas located along a single edge, the tissue proximity detection circuit 114 may provide information about such proximity of human tissue to the antenna control circuit 106. In response, the antenna control circuit 106 may reduce a transmit power level, such as to avoid exceeding a specified SAR threshold during transmission in proximity to the human tissue. When human tissue comes within a specified range of a proximity sensor (e.g., within about 10 mm of the first proximity sensor 122A), the wireless communication circuit 116 may reduce a transmission power output to the first antenna 124A by a specified amount, such as including a reduction of several decibels.

In another approach, a fixed attenuation factor (e.g., a fixed reduction in transmission power) may be determined during regulatory testing so that the transmission power always remains below a specified threshold SAR under all anticipated usage conditions, regardless of human tissue proximity

Unlike approaches including power adjustment alone, one or more of the antennas such as the first or second antennas 124A through 124B may be selected to provide reception and transmission, such as in the absence of nearby human tissue, or reception alone, such as in the presence of nearby human tissue. Such antenna selection may be used to maintain a high total radiated power (TRP), even in the presence of human tissue nearby one or more of the first through third edges 126A through 126C.

In the illustrative embodiment shown in FIG. 2, the first antenna 124A may be located on the first edge 126A at an angle perpendicular to the second antenna 124B or the second edge 126B. In an embodiment, one or more of the first or the second antennas 124A through 124B may located opposite each other, such as including locating the second antenna 124B on a third edge 126C opposite the first edge 126A. In an embodiment, one or more of the first and second antennas 124A through 124B may be used for transmission or receipt of electromagnetic energy, such as controlled using an antenna control circuit 106.

In an embodiment, one or more techniques may be used to obtain information indicative of the presence or absence of human tissue on or nearby the housing 128 of the portable wireless device 200. For example, one or more of the first or second proximity sensors 122A through 122B may include a conductive sensor (e.g., an electrode), a capacitive sensor, a mechanical switch, an optical sensor, an acoustic sensor, or one or more other sensing modalities. In an embodiment, information obtained from multiple sensing modalities may be used such as to increase a confidence level that human tissue is present or absent within a specified range of a respective proximity sensor.

In an embodiment, the tissue proximity detection circuit 114 may use information about an electrical characteristic of one or more of the first antenna 124A or second antenna 124B in addition, or instead of, using the first proximity sensor 122A or the second proximity sensor 122B. For example, one or more of a return loss (e.g., a reflected power), an input impedance, or one or more other electrical characteristics of the first or second antennas 124A through 124B may be monitored.

A change in an electrical characteristic, such as an increase or a decrease in return loss, a change in impedance beyond a specified range or threshold (e.g., a magnitude, a phase, a real part, or an imaginary part), or one or more other electrical characteristics may be used such as to provide information indicative of a presence or absence of human tissue respectively nearby first antenna 124A or the second antenna 124B. In an illustrative example, amplitude or phase information about power reflected from an antenna may be monitored such as a via a directional coupler included in-line with an antenna feed, such as a first feed 130A or a second feed 130B, coupling the antenna to the wireless communication circuit 116.

In an illustrative embodiment, the wireless communication circuit 116 may include a receive front-end, such as including one or more receive ports, and transmit front-end, such as including one or more transmit ports. A solid-state or mechanical switch may be used, such as controlled by the antenna control circuit 106, such as to controllably isolate or connect one or more of the first or second antennas 124A through 124B to one or more of a transmit port or a receive port of the wireless communication circuit 116.

In an illustrative embodiment, the wireless communication circuit 116 may include a transmit/receive port, and a receive-only port. In such an embodiment, the antenna control circuit 106 may controllably connect one of the first or second antennas 124A through 124B to the receive-only port when human tissue is detected within a specified range of the corresponding antenna, such as inhibiting transmission by the antenna connected to the receive-only port.

In an embodiment, and as discussed above in relation to FIG. 1, one or more of the tissue proximity detection circuit 114, wireless communication circuit 116, or antenna control circuit 106 may be co-integrated or included as separate modules. For example, one or more of the tissue proximity detection circuit or antenna control circuit 106 may be separate from the wireless communication circuit, such as included in-line with one or more antenna feeds coupled respectively between an antenna and the wireless communication circuit 116. In an embodiment, tissue proximity detection circuit may provide antenna selection information to one or more of the wireless communication circuit 116, or a separate switch module, such as a double-pole-double-throw radio-frequency (RF) switch.

In an illustrative embodiment, such as in a WWAN application including multi-input multi-output (MIMO) communication, more than two antennas may be included in the portable wireless device 200. In an illustrative example of a 2×2 MIMO system, (e.g., an 2×2 MIMO LTE system), in any SAR testing orientation, the two antennas furthest away from the phantom or user's tissue may be selected for 2×2 communication. If no two antennas are available that are far away from the phantom or user tissue, the portable wireless device may fall back to 1×2 MIMO, such as receiving using two antennas, but transmitting with only a single antenna located away from tissue, or transmitting at reduced power if no antennas are sufficiently far away from tissue. Higher-order MIMO implementations may also be used, such as via correspondingly increasing the number of available antennas or proximity sensors. For example, one or more antennas may also be located on a back face of the portable wireless device 200.

FIG. 3 illustrates generally a technique 300, such as a method, that may include obtaining information indicative of a presence or absence of human tissue and controllably inhibiting transmission by an antenna in response to the obtained information. In an embodiment, at 302, information may be obtained, the information indicative of the presence or absence of human tissue within a specified range of a first or a second antenna. Such information may include sensing an impedance of a first antenna, such as using apparatus or devices discussed above with respect to FIGS. 1 through 2.

At 304, a presence or absence of human tissue within a specified range of the first antenna may be determined, such as using the sensed impedance of the first antenna.

At 306, transmission by the first antenna may be inhibited, such as in response to the obtained information indicative of the presence of human tissue nearby within a specified range. For example, when a body region (e.g., a torso, a hand, a lap, or an appendage) is located on or near one or more antennas, another more far away antenna may be used instead (or additionally). In an embodiment, transmission by the second antenna may still be permitted.

In an embodiment, the first antenna may still be permitted to operate as a receive antenna, despite the information indicative of nearby tissue. Other operational schemes may be used, such as discussed above or below, such as in FIG. 4.

FIG. 4 illustrates generally a technique 400, such as a method, that may include detecting a presence or absence of human tissue nearby a proximity sensor and in response, selecting an antenna for use in transmission.

In an illustrative example, such as including apparatus or techniques such as discussed above in FIGS. 1-3, at 402, a default configuration of a portable wireless device may include using a first antenna in a receive-only mode. A second antenna may be used in both a transmit and a receive mode. A transmit (TX) power may be set to a specified level, such as a “full TX power.” At 404, if human tissue is not detected within a specified range of the second antenna, the TX power level remains at “full TX power.”

If, at 406, human tissue is not detected within a specified range of the first antenna, then, at 408, the first antenna may now be used in both a transmit and a receive mode, and the second antenna may be restricted to a receive-only mode, such as to avoid exceeding a specified SAR exposure threshold in tissue that may be located next to the second antenna as identified at 404. In an embodiment, if human tissue was identified within a specified range of both the first antenna and the second antenna, then at 410, the TX power level may be controllably adjusted (e.g., throttled), such as to maintain compliance with a specified SAR exposure threshold despite the presence of tissue nearby both the first antenna and the second antenna.

### Various Notes and Examples

Example 1 can include subject matter (such as an apparatus, a method, a means for performing acts, or a machine readable medium including instructions that, when performed by the machine, that can cause the machine to perform acts), such as may include a portable wireless device comprising a tissue proximity detection circuit to provide information indicative of a presence or absence of human tissue within a specified range of a first antenna, an antenna control circuit to controllably inhibit transmission by the first antenna and to permit transmission by a second antenna and a third antenna, in response to information provided by the tissue proximity detection circuit that human tissue is present within the specified range of the first antenna, and a wireless communication circuit communicatively coupled to the antenna control circuit, the wireless communication circuit to wirelessly transfer information in accordance with a MIMO multi-input multi-output communication scheme using the second and third antennas for transmission and at least two of the first, second, or third antennas for receiving.

Example 2 can include, or can optionally be combined with the subject matter of Example 1, to optionally include a housing, a first antenna located on a first edge of the housing, and a second antenna located on a second edge of the housing.

Example 3 can include, or can optionally be combined with the subject matter of one or any combination of Examples 1 or 2 to optionally include a housing comprising a tablet device housing, the first antenna located on a first edge in or near a position on or near a body of a user, the second antenna located on a second edge more distal to the position on or near the body of the user.

Example 4 can include, or can optionally be combined with the subject matter of one or any combination of Examples 1 through 3 to optionally include a housing comprising a tablet device housing, a first antenna located on a first edge and a second antenna located on a second edge, the first and second edges substantially perpendicular to each other.

Example 5 can include, or can optionally be combined with the subject matter of one or any combination of Examples 1 through 4 to optionally include a housing comprising a tablet device housing, a first antenna located on a first edge and a second antenna located on a second edge, the first and second edges are located opposite each other.

Example 6 can include, or can optionally be combined with the subject matter of one or any combination of Examples 1 through 5 to optionally include a tissue proximity detection circuit configured to detect a presence or absence of human tissue within the specified range using one or more of an optical tissue sensor, a conductive tissue sensor, or an acoustic tissue sensor.

Example 7 can include, or can optionally be combined with the subject matter of one or any combination of Examples 1 through 6 to optionally include a tissue proximity detection circuit configured to detect a presence or absence of human tissue within the specified range via monitoring one or more electrical characteristics of the first antenna to detect the presence or absence of tissue.

Example 8 can include, or can optionally be combined with the subject matter of one or any combination of Examples 1 through 7 to optionally include one or more electrical characteristics comprising one or more of an input impedance of the first antenna or a return loss of the first antenna.

Example 9 can include, or can optionally be combined with the subject matter of one or any combination of Examples 1 through 8 to optionally include a tissue proximity detection circuit configured to provide information indicative of a presence or absence of human tissue within a specified range of the second antenna, and an antenna control circuit configured to controllably inhibit transmission by the second antenna, and to allow transmission by the first antenna, in response to information provided by the tissue proximity detection circuit that human tissue is present within the specified range of the second antenna but not within the specified range of the first antenna.

Example 10 can include, or can optionally be combined with the subject matter of one or any combination of Examples 1 through 9 to optionally include an antenna control circuit configured to controllably adjust a transmission power used by one or more of the first or second antennas in response to information provided by the tissue proximity detection circuit that human tissue is present within a specified range of both the first and second antennas.

Example 11 can include, or can optionally be combined with the subject matter of one or any combination of Examples 1 through 10 to optionally include a tissue proximity detection circuit configured to provide information indicative of a presence or absence of human tissue within a specified range of the second antenna, an antenna control circuit configured to controllably inhibit transmission by the first antenna and the second antenna, and to permit transmission by the third antenna, in response to the obtained information that human tissue is present within a specified range of both the first and second antennas, and a wireless communication circuit configured to wirelessly transfer information in accordance with a communication scheme using the third antenna for transmission, and at least two of the first, second, or third antennas for receiving.

Example 12 can include, or can optionally be combined with the subject matter of one or any combination of Examples 1 through 11 to optionally include an antenna control circuit comprising a mechanical or a solid-state switch, the antenna control circuit configured to controllably inhibit transmission by the first antenna using the switch.

Example 13 can include, or can optionally be combined with the subject matter of one or any combination of Examples 1 through 12 to optionally include a wireless communication circuit, the wireless communication circuit configured to wirelessly transfer digital information electromagnetically between the portable device and the remote apparatus in accordance with at least one of a second-generation (2G), a third-generation (3G), or a fourth-generation (4G) digital wireless communication standard.

Example 14 can include, or can optionally be combined with the subject matter of one or any combination of Examples 1 through 13 to optionally include a wireless communication standard including a WiMax communication standard or a 3GPP LTE communication standard.

Example 15 can include, or can optionally be combined with the subject matter of one or any combination of Examples 1-14 to include, subject matter (such as an apparatus, a method, a means for performing acts, or a machine readable medium including instructions that, when performed by the machine, that can cause the machine to perform acts), such as can include a portable wireless device comprising at least one processor circuit, a memory circuit coupled to at least one processor circuit, the memory circuit including processor-readable instructions that, when performed by at least one processor circuit, cause the at portable wireless device to obtain information indicative of the presence or absence of human tissue within a specified range of the first or the second antenna using a tissue proximity detection circuit and controllably inhibit transmission by the first antenna, and to allow transmission by the second antenna, in response to the obtained information that human tissue is present within the specified range of the first antenna.

Example 16 can include, or can optionally be combined with the subject matter of Example 15, to optionally include a memory circuit including instructions that cause the portable wireless device to obtain information indicative of a presence or absence of human tissue within a specified range of the second antenna, and controllably inhibit transmission by the second antenna and allow transmission by the first antenna, in response to the obtained information that human tissue is present within the specified range of the second antenna but not within the specified range of the first antenna.

Example 17 can include, or can optionally be combined with the subject matter of one or any combination of Examples 15 or 16 to optionally include a memory circuit including instructions that cause the portable wireless device to adjust a transmission power used by one or more of the first or second antennas in response to the obtained information that human tissue is present within a specified range of both the first and second antennas.

Example 18 can include, or can optionally be combined with the subject matter of one or any combination of Examples 15 through 17 to optionally include a transmission power specified to provide a Specific Absorption Rate that falls at or below an exposure threshold established by ANSI/IEEE C95.1-1992.

Example 19 can include, or can optionally be combined with the subject matter of one or any combination of Examples 1-18 to include, subject matter (such as an apparatus, a method, a means for performing acts, or a machine readable medium including instructions that, when performed by the machine, that can cause the machine to perform acts), such as can include sensing a change in an electrical characteristic of a first antenna, obtaining information indicative of the presence or absence of human tissue within a specified range of the first antenna using the sensed change in the electrical characteristic of the first antenna, controllably inhibiting transmission by the first antenna and permitting transmission by the second antenna, in response to the obtained information that human tissue is present within the specified range of the first antenna.

Example 20 can include, or can optionally be combined with the subject matter of Example 15, to optionally include permitting the first antenna to receive wireless information electromagnetically despite the presence of human tissue within the specified range, and adjusting a transmission power used by one or more of the first or second antennas in response to the obtained information that human tissue is present within a specified range of both the first and second antennas, the transmission power specified to provide a Specific Absorption Rate that falls at or below an exposure threshold established by ANSUIEEE C95.1-1992.

Example 21 can include, or can optionally be combined with any portion or combination of any portions of any one or more of Examples 1-20 to include, subject matter that can include means for performing any one or more of the functions of Examples 1-20, or at least one machine-readable medium including instructions that, when performed by a machine, cause the machine to perform any one or more of the functions of Examples 1-20.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include at least one computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. A portable wireless device comprising:
a tissue proximity detection circuit to provide information indicative of a presence or absence of human tissue within a specified range of a first antenna;
an antenna control circuit to controllably inhibit transmission by the first antenna and to permit transmission by a second antenna and a third antenna, in response to information provided by the tissue proximity detection circuit that human tissue is present within the specified range of the first antenna; and
a wireless communication circuit communicatively coupled to the antenna control circuit, the wireless communication circuit to wirelessly transfer information in accordance with a MIMO multi-input multi-output communication scheme using the second and third antennas for transmission and at least two of the first, second, or third antennas for receiving.

2. The portable wireless device of claim 1, comprising:
a housing;
wherein the first antenna is located on a first edge of the housing, and wherein the second antenna is located on a second edge of the housing.

3. The portable wireless device of claim 2, wherein the housing includes a tablet device housing, and wherein the first antenna is located on a first edge in or near a position on or near a body of a user; and
wherein the second antenna is located on a second edge more distal to the position on or near the body of the user.

4. The portable wireless device of claim 2, wherein the housing includes a tablet device housing;
wherein the first antenna is located on a first edge and the second antenna is located on a second edge; and
wherein the first and second edges are substantially perpendicular to each other.

5. The portable wireless device of claim 2, wherein the housing includes a tablet device housing;
wherein the first antenna is located on a first edge and the second antenna is located on a second edge; and
wherein the first and second edges are located opposite each other.

6. The portable wireless device of claim 1, wherein the tissue proximity detection circuit is configured to detect a presence or absence of human tissue within the specified range using one or more of an optical tissue sensor, a conductive tissue sensor, or an acoustic tissue sensor.

7. The portable wireless device of claim 1, wherein the tissue proximity detection circuit is configured to detect a presence or absence of human tissue within the specified range via monitoring one or more electrical characteristics of the first antenna to detect the presence or absence of tissue.

8. The portable wireless device of claim 7, wherein the one or more electrical characteristics include one or more of an input impedance of the first antenna or a return loss of the first antenna.

9. The portable wireless device of claim 1,
wherein the tissue proximity detection circuit is configured to provide information indicative of a presence or absence of human tissue within a specified range of the second antenna; and
an antenna control circuit configured to controllably inhibit transmission by the second antenna, and to allow transmission by the first antenna, in response to information provided by the tissue proximity detection circuit that human tissue is present within the specified range of the second antenna but not within the specified range of the first antenna.

10. The portable wireless device of claim 9, wherein the antenna control circuit is configured to controllably adjust a transmission power used by one or more of the first or second antennas in response to information provided by the tissue proximity detection circuit that human tissue is present within a specified range of both the first and second antennas.

11. The portable wireless device of claim 1, wherein the tissue proximity detection circuit is configured to provide information indicative of a presence or absence of human tissue within a specified range of the second antenna;
wherein the antenna control circuit is configured to controllably inhibit transmission by the first antenna and the second antenna, and to permit transmission by the third antenna, in response to the obtained information that human tissue is present within a specified range of both the first and second antennas; and
wherein the wireless communication circuit is configured to wirelessly transfer information in accordance with a MIMO multi-input multi-output communication scheme using the third antenna for transmission, and at least two of the first, second, or third antennas for receiving.

12. The portable wireless device of claim 1, wherein the antenna control circuit is electrically coupled to a mechanical or a solid-state switch; and
wherein the antenna control circuit is configured to controllably inhibit transmission by the first antenna using the switch.

13. The portable wireless device of claim 1, wherein the portable wireless device includes a wireless communication circuit, and wherein the wireless communication circuit is configured to wirelessly transfer digital information electromagnetically between the portable device and the remote apparatus in accordance with at least one of a second-generation (2G), a third-generation (3G), or a fourth-generation (4G) digital wireless communication standard.

14. The portable wireless device of claim 13, wherein the wireless communication standard includes a standard defined by an IEEE 802.16 WiMax standards family or a standard defined by a 3GPP LTE/LTE-A standards family.

15. A portable wireless device comprising:
at least one processor circuit;
a memory circuit coupled to at least one processor circuit, the memory circuit including processor-readable instructions that, when performed by at least one processor circuit, cause the at portable wireless device to:
obtain information indicative of the presence or absence of human tissue within a specified range of the first or the second antenna using a tissue proximity detection circuit; and
controllably inhibit transmission by the first antenna, and to allow transmission by the second antenna, in response to the obtained information that human tissue is present within the specified range of the first antenna.

16. The portable wireless device of claim 15, wherein the memory circuit includes instructions that cause the portable wireless device to:
obtain information indicative of a presence or absence of human tissue within a specified range of the second antenna; and
controllably inhibit transmission by the second antenna and allow transmission by the first antenna, in response to the obtained information that human tissue is present within the specified range of the second antenna but not within the specified range of the first antenna.

17. The portable wireless device of claim 16, wherein the memory circuit includes instructions that cause the portable wireless device to adjust a transmission power used by one or more of the first or second antennas in response to the obtained information that human tissue is present within a specified range of both the first and second antennas.

18. The portable wireless device of claim 17, wherein the transmission power is specified to provide a Specific Absorption Rate that falls at or below an exposure threshold established by guideline defined by ANSI/IEEE C95.1-1992.

19. A method for antenna selection in a portable wireless device, the method comprising:
sensing an impedance of a first antenna;
determining a presence or absence of human tissue within a specified range of the first antenna using the sensed impedance of the first antenna; and
controllably inhibiting transmission by the first antenna and permitting transmission by the second antenna, in response to the obtained information that human tissue is present within the specified range of the first antenna.

20. The method of claim 19, comprising:
permitting the first antenna to receive wireless information electromagnetically despite the presence of human tissue within the specified range; and
adjusting a transmission power used by one or more of the first or second antennas in response to the obtained information that human tissue is present within a specified range of both the first and second antennas;
wherein the transmission power is specified to provide a Specific Absorption Rate that falls at or below an exposure threshold established by guideline defined by ANSI/IEEE C95.1-1992.
